(19) United States
(12) Patent Application Publication
(10) Pub. No.: US 2019/0019157 A1
(43) Pub. Date: Jan. 17, 2019

(54) GENERALIZING MIXED EFFECT MODELS FOR PERSONALIZING JOB SEARCH

(71) Applicant: LinkedIn Corporation, Sunnyvale, CA (US)

(72) Inventors: Ankan Saha, San Francisco, CA (US); Dhruv Arya, Sunnyvale, CA (US)

(21) Appl. No.: 15/648,798

(22) Filed: Jul. 13, 2017

(51) Int. Cl. G06Q 10/10; G06N 99/00; G06F 17/30

(52) U.S. Cl. CPC G06Q 10/1053; G06Q 50/01; G06F 17/30867; G06N 99/005

(57) ABSTRACT

In an example embodiment, a generalized linear mixed effect model is trained using sample job posting results resulting from sample queries from sample members having sample member data. The generalized linear mixed effect model has coefficients based on a global ranking model as well as coefficients based on features from job posting results. The generalized linear mixed effect model may be trained to output application likelihood scores for each of a plurality of candidate job posting results produced by a query from a first member. The application likelihood scores may then be used to sort the candidate job posting results.

### TECHNICAL FIELD

The present disclosure generally relates to technical problems encountered in personalizing job searches on computer networks. More specifically, the present disclosure related to the use of generalized mixed effect models for personalizing job searches.

### BACKGROUND

The rise of the Internet has occasioned two disparate phenomena: the increase in the presence of social networks, with their corresponding member profiles visible to large numbers of people, and the increase in the use of these social networks to perform searches for jobs that have been posted on or linked to by the social networks.

A technical problem encountered by social networking services in managing online job searches is that determining how to serve the most appropriate and relevant job results with minimal delay becomes significantly challenging as the number of sources and volumes of job opportunities via the social networking services grows at an unprecedented pace.

Personalization of job search results is also preferential. For example, when a user searches for a query like “software engineer”, depending on the skills, background, experience, location, and other factors about the user, the ranked list of results can be drastically different. Thus, for example, a person skilled in machine learning would see a very different set of job results compared to someone specializing in hardware or computer networks.

Historically, algorithms to rank job search results in response to a query have heavily utilized text and entity-based features extracted from the query and job postings to derive a global ranking. However, when such global ranking algorithms are modified to improve certain queries, other queries tend to become degraded. Specifically, the queries that often become degraded are those where personalization is desired, such as in the “software engineer” example provided above. Given the prevalence of such job search queries, it would be beneficial to have a technical solution for providing highly relevant job posting results even if the global ranking model cannot generalize well for these types of queries.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system 100, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating an application server module of FIG. 2 in more detail, in accordance with an example embodiment.

FIG. 4 is a block diagram illustrating a job posting result ranking engine of FIG. 3 in more detail, in accordance with an example embodiment.

FIG. 5 is a flow diagram illustrating a method to sort candidate job posting results produced by queries in a social networking service, in accordance with an example embodiment.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a system is provided wherein a machine learning model is built that operates on a per-query bases on the space of job features. Per-query coefficients corresponding to job features are generated and combined with a global model to output a similarity score. In some example embodiments, generalized linear mixed effect models (GLMix) are used to improve job search results. In the context of job searching, one key aspect is to show the best jobs to a user based on his or her query, according to some measure. In one example embodiment, this measure may be quantified as the likelihood of member m applying for job j if served when he or she enters the query q, measured by the binary response yₘⱼₛ. sⱼ denotes the feature vector of job j, which includes features extracted from the job posting, such as the job title, summary, location, desired skills, and experience needed. x_{mjq} represents the overall feature vector for the (m, j, q) triple, which can include member, job, query, and associated context features and any combination thereof.

Specifically, a generalized mixed effect model is trained using sample job posting results and sample member data, including information on what queries produced the sample job posting results and an indication that particular members applied to particular sample job posting results (or otherwise expressed interest in the results). The generalized mixed effect model is then trained on the space of job-features in addition to a global model. This allows finer signals in the training data to be captured, thus allowing for better differentiation on how the presence of a particular job skill should generate job posting results as opposed to another skill.

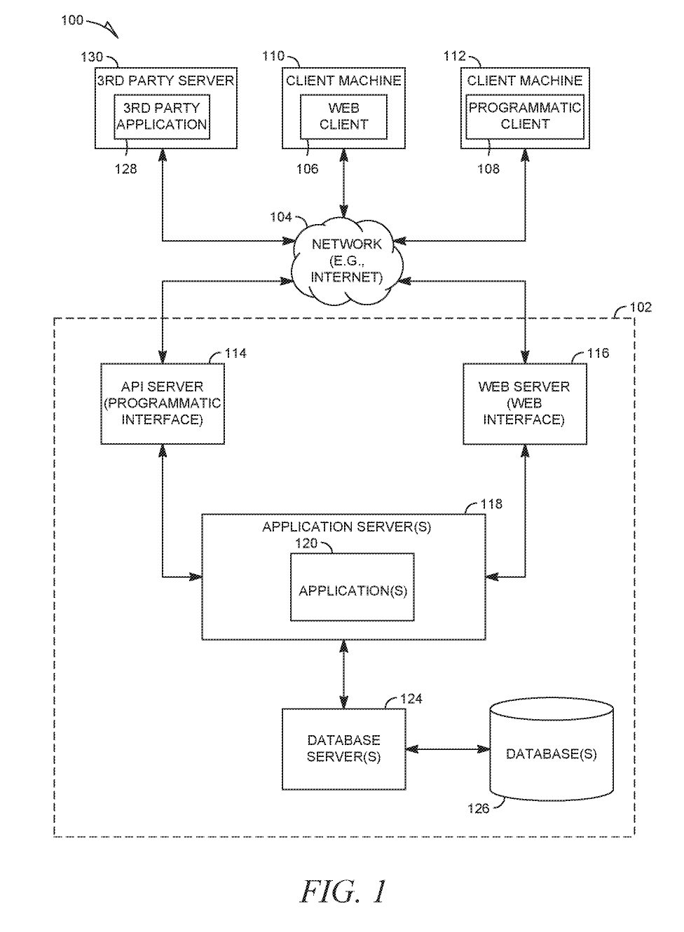

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

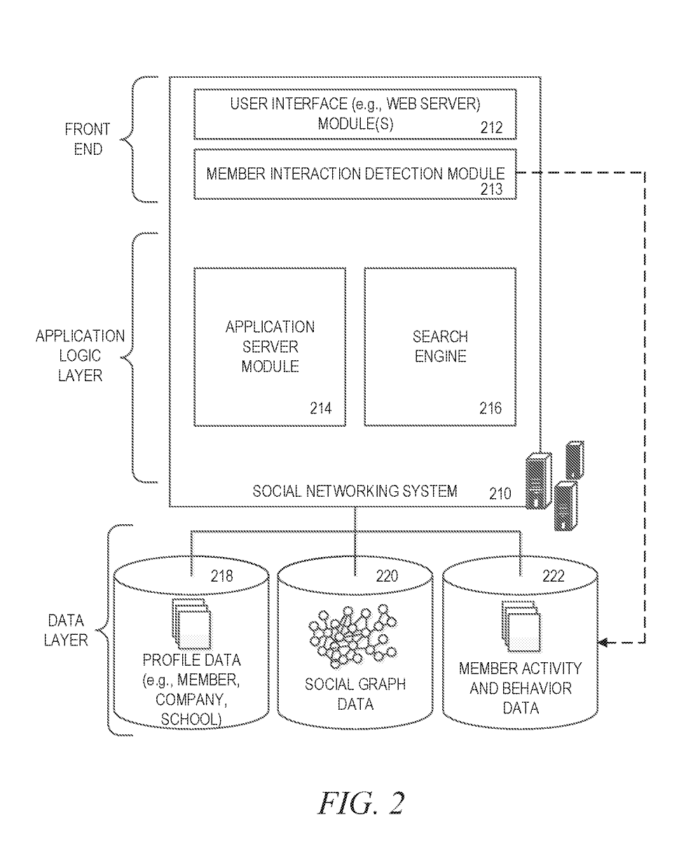

In some embodiments, the networked system 102 may comprise functional components of a social networking service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the social networking service.

As shown in FIG. 2, the data layer may include several databases 126, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or offline) to generate various derived profile data. For example, if a member has provided information about various job titles that the member has held with the same organization or different organizations, and for how long, this information can be used to infer or derive a member profile attribute indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources and made part of an organization's profile. This importation of organization data and enrichment of the data will be described in more detail later in this document.

Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API module via which applications 120 and services can access various data and services provided or maintained by the social networking service. For example, using an API, an application may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service, nothing other than data privacy concerns prevents the API from being provided to the public or to certain third parties under special arrangements, thereby making the navigation recommendations available to third party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222), as well as job postings. The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

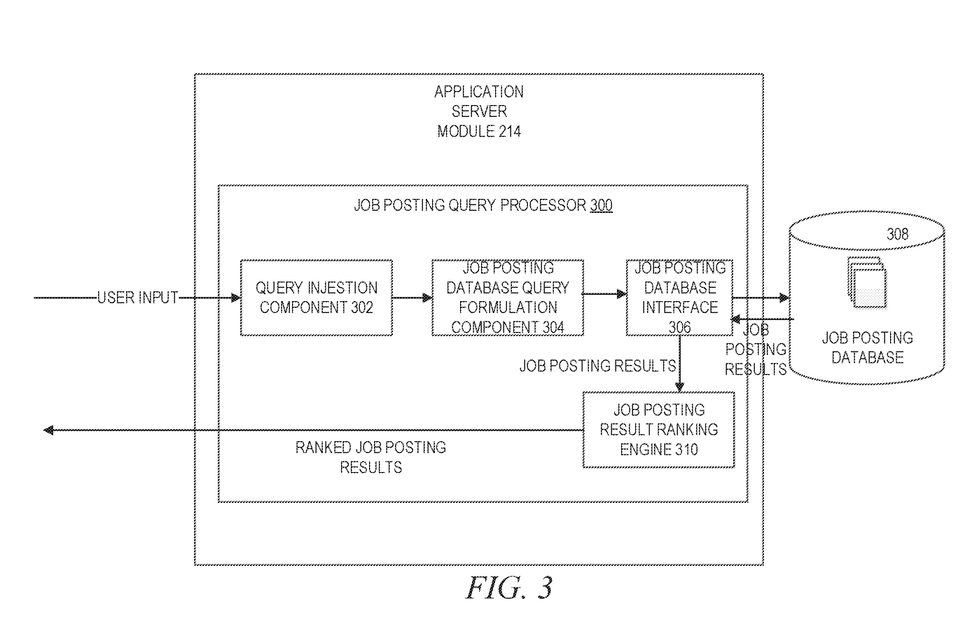

FIG. 3 is a block diagram illustrating application server module 214 of FIG. 2 in more detail, in accordance with an example embodiment. While, in many embodiments, the application server module 214 will contain many subcomponents used to perform various different actions within the social networking system, in FIG. 3 only those components that are relevant to the present disclosure are depicted. A job posting query processor 300 comprises a query injection component 302, which receives a user input “query” related to a job posting search via a user interface (not pictured). Notably, this user input may take many forms. In some example embodiments, the user may explicitly describe a job posting search query, such as by entering one or more keywords or terms into one or more fields of a user interface screen. In other example embodiments, the job posting query may be inferred based on one or more user actions, such as selection of one or more filters, other job posting searches by the user, searches for other members or entities, etc.

This “query” may be sent to a job posting database query formulation component 304, which formulates an actual job posting database query, which will be sent via a job posting database interface 306 to job posting database 308. Job posting results responsive to this job posting database query may then be sent to the job posting result ranking engine 310, again via the job posting database interface 306. The job posting result ranking engine 310 then ranks the job posting results and sends the ranked job posting results back to the user interface for display to the user.

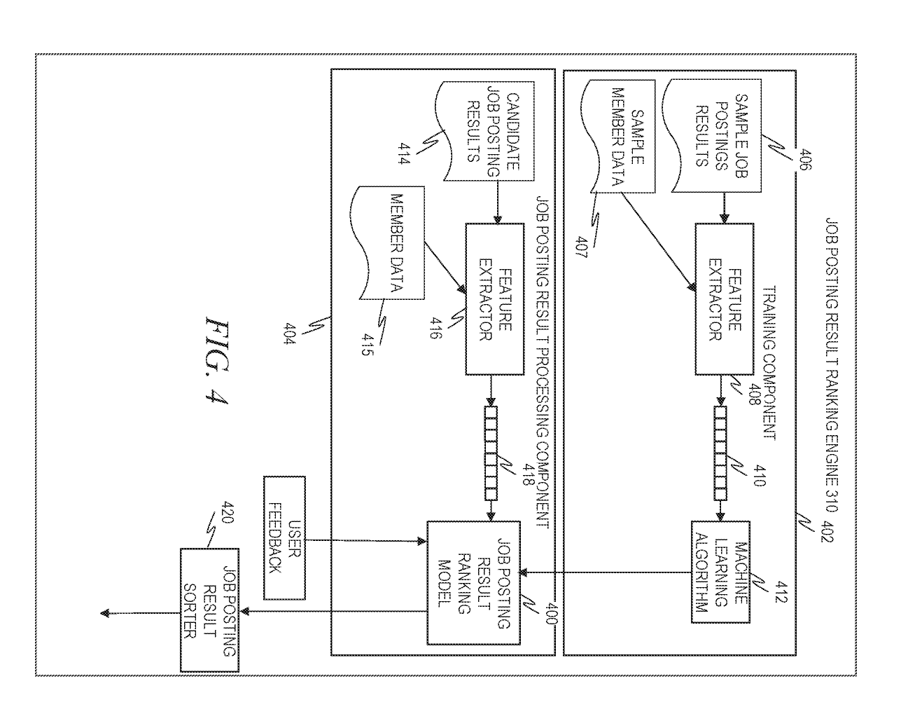

FIG. 4 is a block diagram illustrating job posting result ranking engine 310 of FIG. 3 in more detail, in accordance with an example embodiment. The job posting result ranking engine 310 may use machine learning techniques to learn a job posting result ranking model 400, which can then be used to rank actual job posting results from the job posting database 308.

The job posting result ranking engine 310 may comprise a training component 402 and a job posting result processing component 404. The training component 403 feeds sample job postings results 406 and sample member data 407 into a feature extractor 408 that extracts one or more features 410 for the sample job postings results 406 and sample member data 407. The sample job postings results 406 may each include job postings results produced in response to a particular query as well as one or more labels, such as a job posting application likelihood score, which is a score indicating a probability that a member with a corresponding sample member data 407 will apply for the job associated with the corresponding sample job postings result 406.

Sample member data 407 may include, for example, a history of job searches and resulting expressions of interest (such as clicking on job posting results or applications to corresponding jobs) in particular job posting results for particular members. In some example embodiments, sample member data 407 can also include other data relevant for personalization of the query results to the particular member, such as a member profile for the member or a history of other member activity.

A machine learning algorithm 412 produces the job posting result ranking model 400 using the extracted features 410 along with the one or more labels. In the job posting result processing component 404, candidate job postings results 414 resulting from a particular query are fed to a feature extractor 416 along with a candidate member data 415. The feature extractor 416 extracts one or more features 418 from the candidate job postings results 414 and candidate member data 415. These features 418 are then fed to the job posting result ranking model 400, which outputs a job posting application likelihood score for each candidate job postings result for the particular query.

This job posting application likelihood score for each candidate job posting result may then be passed to a job posting result sorter 420, which may sort the candidate job postings results 414 based on their respective job posting application likelihood scores.

It should be noted that the job posting result ranking model 400 may be periodically updated via additional training and/or user feedback. The user feedback may be either feedback from members performing searches, or from companies corresponding to the job postings. The feedback may include an indication about how successful the job posting result ranking model 400 is in predicting member interest in the job posting results presented.

The machine learning algorithm 412 may be selected from among many different potential supervised or unsupervised machine learning algorithms 412. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. In an example embodiment, a multi-class logistical regression model is used.

It should be noted that one technical issue with utilizing a learning to rank (LTR) metric using coordinate assent as part of the machine learning algorithm 412 is that the global features do not capture relationships between individual queries and jobs. This technical problem can be overcome by obtaining a notion of affinity of the query string with the job-features associated with the job posting. While this can be achieved by introducing interaction features between each query string and job posting feature, that would make the feature space prohibitively expensive and training the model very difficult.

In an example embodiment, the notion of affinity of the query string with the job features associated with the job posting can be obtained by using one or more mixed effect models which can exploit the interaction of each query with the job features explicitly.

In an example embodiment, a GLMix model is used to predict the probability of member m applying for job j based on query q using logistic regression. This GLMix model may be, for example:

g(E[y_{mjq}])=x′_{mjq}b+s′_{jβq}

where

$$g ( E [ {y}_{mjq} ] ) = log \frac{E [ {y}_{mjq} ]}{1 - E [ {y}_{mjq} ]}$$

is the link function, b is the global coefficient vector (also called fixed effect coefficients) and β_{q} are the coefficient vectors specific to query q, called random effects coefficients, which capture query q's association or relationship with different job functions.

Note, that in some example embodiments, it is also possible to have similar random effects coefficients αₘ or γⱼ on a per-member or per-job basis, which can then be combined with features on the job-query or member-query spaces respectively. However, with increasingly large numbers of members or jobs, this can make such a model prohibitively expensive to be applied in production, as the final model would have a different set of coefficients for each member and each job and would incur severe latency while generating the scores for a triple at run-time. Applying the random effects via a per-query model on the job-features in conjunction with the global model allows the system to improve the baseline global model significantly in terms of both offline metrics as well as application rates in production. The member features tend to be mostly static, and thus do not contribute much when added into the per-query model.

In an example embodiment, the model described above is optimized via alternating optimization using parallelized coordinate descent. Here, the system may alternately optimize for the global features and the per-query features for each query while holding all other variables fixed. Specifically, in one example embodiment, the optimization problems for updating the fixed effects b and random effects F are as follows:

$$b = arg {max}_{b} \{ log p ( b ) + {\sum }_{n ∈ Ω} log p ( {y}_{n} \vert {s}_{n} - {x}_{n}^{′} {b}^{old} + {x}_{n}^{′} b ) \} {γ}_{rl} = arg {max}_{{γ}_{rl}} \{ log p ( {γ}_{rl} ) + {\sum }_{n \vert i ( r , n ) = l} log p ( {y}_{n} \vert {s}_{n} - {z}_{rn {γ}_{rl}}^{′ old} + {z}_{rn {γ}_{rl}}^{′} ) \}$$

Incremental updates are performed for s={sₙ}n∈Ω for computational efficiency. More specifically, when the fixed effects b get updated, the following equation is used:

sₙ^{new}=sₙ^{old}−x′ₙb^{old}+x′ₙb^{new}

and when the random effects Γ get updated, the following equation is used:

sₙ^{new}=sₙ^{old}−x′ᵣₙγ_{r,i(r,n)}^{old}+x′ᵣₙγ_{r,i(r,n)}^{new}

As described above, the training component 402 may operate in an offline manner to train the job posting result ranking model 400. The job posting result processing component 404, however, may be designed to operate in either an offline manner or an online manner.

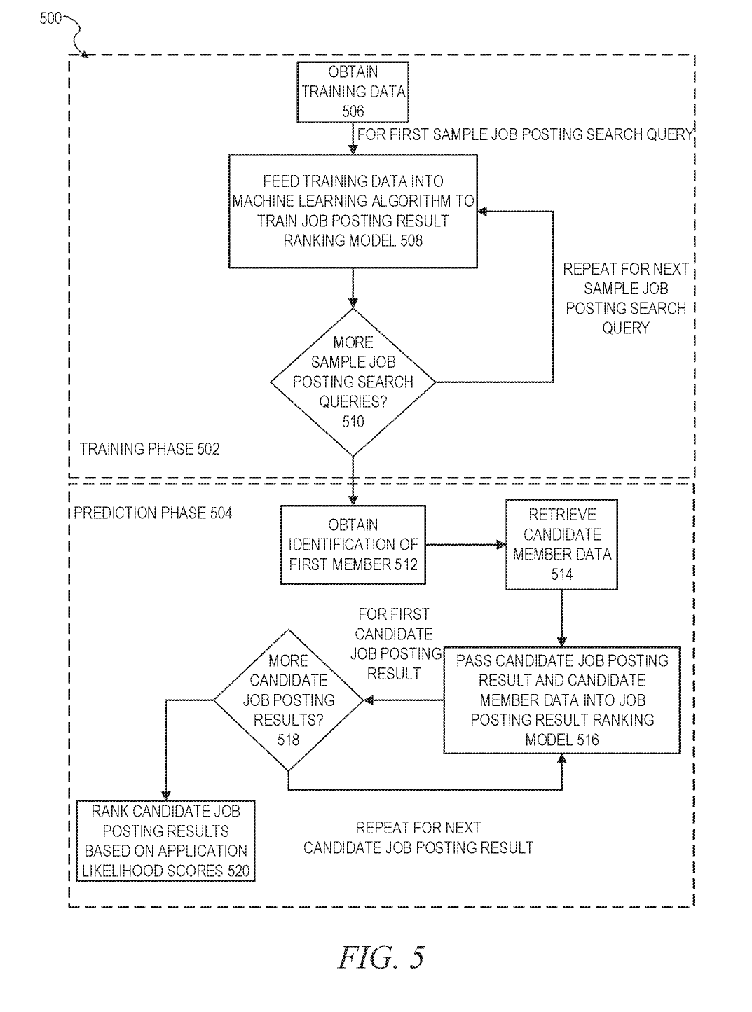

FIG. 5 is a flow diagram illustrating a method 500 to sort candidate job posting results produced by queries in a social networking service, in accordance with an example embodiment. This method 500 may be divided into a training phase 502 and a prediction phase 504. In the training phase 502, at operation 506, training data pertaining to sample job posting search queries and member data corresponding to the job posting search queries is obtained. The training data comprises sample job posting search results and indications as to which of the sample job posting search results were selected by members performing corresponding job posting search queries. Then a loop is begun for each of the sample job posting search queries. At operation 508, the corresponding training data is fed into a machine learning algorithm 412 to train a job posting result ranking model 400 to output a job posting application likelihood score for a candidate job posting result and candidate query from candidate member data 415. Notably, the job posting ranking model contains coefficients corresponding to the sample job posting search query and corresponding to features from job posting results as well as coefficients based on a global ranking model. At operation 510, it is determined if there are any more sample job posting search queries. If so, the method 500 may loop back to operation 508 for the next sample job posting search query. If not, then the method 500 may move to the prediction phase 504.

At operation 512, an identification of a first member of the social networking service is obtained. At operation 514, candidate member data 514 for the first member is retrieved using the identification. Then a loop is begun for each of a plurality of different candidate job posting results 414 retrieved in response to a candidate query from the first member. At operation 516, the candidate job posting result 414 and the candidate member data 415 for the first member are passed to the job posting result ranking model 400 to generate a job posting application likelihood score for the candidate job posting result 414 and the first member. At operation 518, it is determined if there are any more candidate job posting results 414. If so, then the method 500 may loop back to operation 516 for the next candidate job posting result 414. If not, then at operation 520, the plurality of different candidate job posting results 414 are ranked based on the application likelihood scores.

In an example embodiment, the search aspect of the application server module 214 utilizes APACHE® LUCENE® to assist in building an index and retrieve matching entities from the index. A query begins at a browser/device and is passed to a search backend after some preprocessing. The search backend may be a sharded system comprising a single broker and multiple searchers. The role of the broker is to understand the user query, score metadata such as per query model features and coefficients, and build an annotated request for the searcher to execute. Specifically, for the per-query model, the broker fetches the model coefficients and hashed features (for compact storage and efficient matching during retrieval) from a key-value store with the key being a combination of the model name and the query. The annotated request thus built is then broadcasted to all searcher nodes. The searchers hold the sharded index over which the query is executed to obtain the results.

In an example embodiment, searches have a multipass scoring pipeline. Here, a lightweight model may first be used to narrow down the candidate job postings and then the global and per-query model are applied to the set of candidates. The scorer at the searcher may go through the per-query coefficients and, for each job posting result, add the coefficient weights for the features present. Each searcher may take a local view and compute the top k jobs as requested by the broker. These jobs are then passed back to the broker from all the searchers. The broker merges the set of returned jobs and may optionally apply a set of re-rankers to improve the global ranking. The final ranked jobs are then returned to the frontend system where they can be displayed to the members. The candidate selection helps narrow down the jobs to a few job posting results, which are then ranked by the per-query model.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-5 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “Internet of Things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

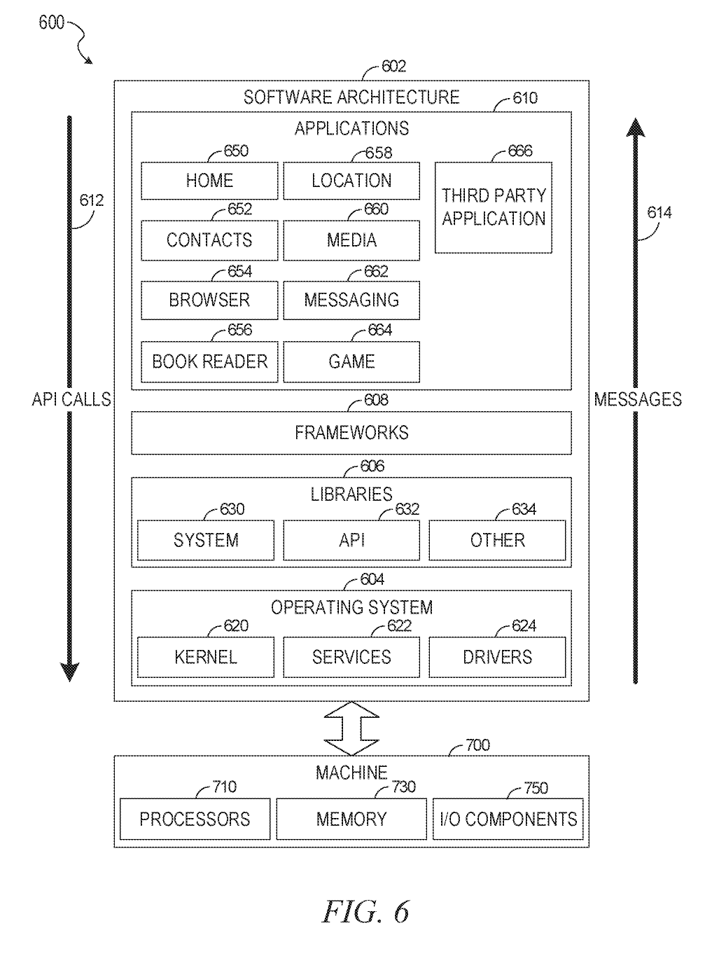

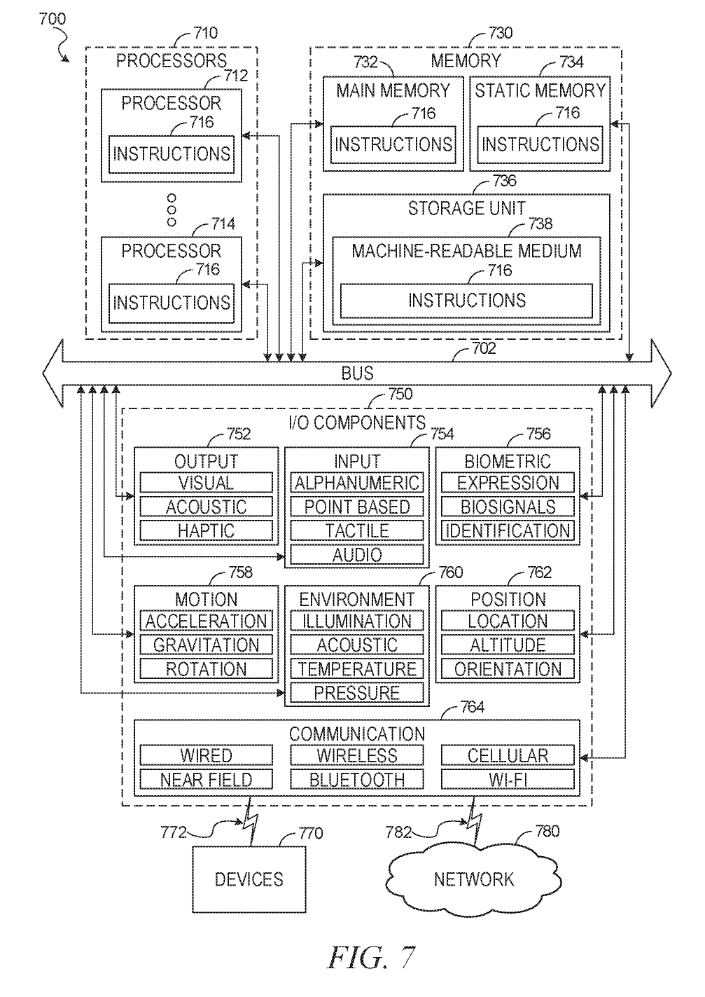

FIG. 6 is a block diagram 600 illustrating a representative software architecture 602, which may be used in conjunction with various hardware architectures herein described. FIG. 6 is merely a non-limiting example of a software architecture, and it will be appreciated that many other architectures may be implemented to facilitate the functionality described herein. The software architecture 602 may be executing on hardware such as a machine 700 of FIG. 7 that includes, among other things, processors 710, memory/storage 730, and I/O components 750. In the example architecture of FIG. 6, the software architecture 602 may be conceptualized as a stack of layers where each layer provides particular functionality. For example, the software architecture 602 may include layers such as an operating system 604, libraries 606, frameworks/middleware 608, and applications 610. Operationally, the applications 610 and/or other components within the layers may invoke API calls 612 through the software stack and receive responses, returned values, and so forth, illustrated as messages 614, in response to the API calls 624. The layers illustrated are representative in nature and not all software architectures have all layers. For example, some mobile or special-purpose operating systems 604 may not provide a layer of frameworks/middleware 618, while others may provide such a layer. Other software architectures may include additional or different layers.

The operating system 604 may manage hardware resources and provide common services. The operating system 604 may include, for example, a kernel 620, services 622, and drivers 624. The kernel 620 may act as an abstraction layer between the hardware and the other software layers. For example, the kernel 620 may be responsible for memory management, processor management (e.g., scheduling), component management, networking, security settings, and so on. The services 622 may provide other common services for the other software layers. The drivers 624 may be responsible for controlling or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 606 may provide a common infrastructure that may be utilized by the applications 610 and/or other components and/or layers. The libraries 606 typically provide functionality that allows other software modules to perform tasks in an easier fashion than by interfacing directly with the underlying operating system 604 functionality (e.g., kernel 620, services 622, and/or drivers 624). The libraries 606 may include system libraries 630 (e.g., C standard library) that may provide functions such as memory allocation functions, string manipulation functions, mathematical functions, and the like. In addition, the libraries 606 may include API libraries 632 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 606 may also include a wide variety of other libraries 634 to provide many other APIs to the applications 610 and other software components/modules.

The frameworks 608 (also sometimes referred to as middleware) may provide a higher-level common infrastructure that may be utilized by the applications 610 and/or other software components/modules. For example, the frameworks 608 may provide various graphic user interface (GUI) functions, high-level resource management, high-level location services, and so forth. The frameworks 608 may provide a broad spectrum of other APIs that may be utilized by the applications 610 and/or other software components/modules, some of which may be specific to a particular operating system 604 or platform.

The applications 610 include built-in applications 650-654 and/or third-party applications 666 Examples of representative built-in applications 650-654 may include, but are not limited to, a contacts application 652, a browser application 654, a book reader application 656, a location application 658, a media application 660, a messaging application 662, and/or a game application 654. The third-party applications 642 may include any of the built-in applications 650-664 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 642 may invoke the API calls 624 provided by the mobile operating system such as the operating system 604 to facilitate functionality described herein.

The applications 620 may utilize built-in operating system 604 functions (e.g., kernel 620, services 622, and/or drivers 624), libraries 606 (e.g., system libraries 630, API libraries 632, and other libraries 634), and frameworks/middleware 608 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with a user.

### Example Machine Architecture and Machine-Readable Medium

FIG. 7 is a block diagram illustrating components of a machine 700, according to some example embodiments, able to read instructions 608 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein may be executed. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors 712, 714 (sometimes referred to as “cores”) that may execute the instructions 716 contemporaneously. Although FIG. 7 shows multiple processors 710, the machine 700 may include a single processor 712 with a single core, a single processor 712 with multiple cores (e.g., a multi-core processor 712), multiple processors 710 with a single core, multiple processors 710 with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor 712's cache memory), or any suitable combination thereof, during execution thereof by the machine 700. Accordingly, the memory 732, the storage unit 736, and the memory of the processors 710 are examples of machine-readable media.

As used herein, “machine-readable medium” means a device able to store instructions 716 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or other suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF47, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a computer-readable medium having instructions stored thereon, which, when executed by a processor, cause the system to:
in a training phase:
obtain training data pertaining to sample job posting search queries and member data corresponding to members issuing the job posting search queries, the training data comprising sample job posting search results and indications as to which of the sample job posting search results were selected by members performing corresponding job posting search queries;
for each of the sample job posting search queries, feed the corresponding training data into a machine learning algorithm to train a job posting result ranking model to output job posting application likelihood scores for a candidate job posting result and candidate query from candidate member data, wherein the job posting ranking model contains coefficients corresponding to the sample job posting search query and to features from job posting results as well as coefficients based on a global ranking model;
in a prediction phase:
obtain an identification of a first member of the social networking service;
retrieve, using the identification, candidate member data for the first member;
for each of a plurality of different candidate job posting results retrieved in response to a candidate query from the first member, pass the candidate job posting result and the candidate member data for the first member to the job posting result ranking model to generate a job posting application likelihood score for the candidate job posting result and the first member; and
rank the plurality of different candidate job posting results based on the application likelihood scores.

2. The system of claim 1, wherein the indications as to which of the sample job posting search results were selected by members performing corresponding job posting search queries including indications as to jobs corresponding to sample job posting search results that were applied to by the members performing the corresponding job posting search queries.

3. The system of claim 1, wherein the global ranking model is a Learning to Rank (LTR) model.

4. The system of claim 1, wherein the job posting result ranking model uses logistic regression.

5. The system of claim 1, wherein the job posting result ranking model is optimized via alternating optimization using parallelized coordinate descent.

6. The system of claim 1, wherein the job posting result ranking model is optimized by optimizing for global features and per-feature queries for each query while holding all other variables fixed.

7. The system of claim 1, wherein the sample member data further includes sample member profiles.

8. A computerized method, comprising
in a training phase:
obtaining training data pertaining to sample job posting search queries and member data corresponding to members issuing the job posting search queries, the training data comprising sample job posting search results and indications as to which of the sample job posting search results were selected by members performing corresponding job posting search queries;
for each of the sample job posting search queries, feeding the corresponding training data into a machine learning algorithm to train a job posting result ranking model to output job posting application likelihood scores for a candidate job posting result and candidate query from candidate member data, wherein the job posting ranking model contains coefficients corresponding to the sample job posting search query and corresponding to features from job posting results as well as coefficients based on a global ranking model;
in a prediction phase:
obtaining an identification of a first member of the social networking service;
retrieving, using the identification, candidate member data for the first member;
for each of a plurality of different candidate job posting results retrieved in response to a candidate query from the first member, passing the candidate job posting result and the candidate member data for the first member to the job posting result ranking model to generate a job posting application likelihood score for the candidate job posting result and the first member; and
ranking the plurality of different candidate job posting results based on the application likelihood scores.

9. The method of claim 8, wherein the indications as to which of the sample job posting search results were selected by members performing corresponding job posting search queries include indications as to jobs corresponding to sample job posting search results for jobs that were applied to by the members performing the corresponding job posting search queries.

10. The method of claim 8, wherein the global ranking model is a Learning to Rank (LTR) model.

11. The method of claim 8, wherein the job posting result ranking model uses logistic regression.

12. The method of claim 8, wherein the job posting result ranking model is optimized via alternating optimization using parallelized coordinate descent.

13. The method of claim 8, wherein the job posting result ranking model is optimized by optimizing for global features and per-feature queries for each query while holding all other variables fixed.

14. The method of claim 8, wherein the sample member data further includes sample member profiles.

15. A non-transitory machine-readable storage medium comprising instructions which, when implemented by one or more machines, cause the one or more machines to perform operations comprising:
in a training phase:
obtaining training data pertaining to sample job posting search queries and member data corresponding to members issuing the job posting search queries, the training data comprising sample job posting search results and indications as to which of the sample job posting search results were selected by members performing corresponding job posting search queries;
for each of the sample job posting search queries, feeding the corresponding training data into a machine learning algorithm to train a job posting result ranking model to output job posting application likelihood scores for a candidate job posting result and candidate query from candidate member data, wherein the job posting ranking model contains coefficients corresponding to the sample job posting search query and corresponding to features from job posting results as well as coefficients based on a global ranking model;
in a prediction phase:
obtaining an identification of a first member of the social networking service;
retrieving, using the identification, candidate member data for the first member;
for each of a plurality of different candidate job posting results retrieved in response to a candidate query from the first member, passing the candidate job posting result and the candidate member data for the first member to the job posting result ranking model to generate a job posting application likelihood score for the candidate job posting result and the first member; and
ranking the plurality of different candidate job posting results based on the application likelihood scores.

16. The non-transitory machine-readable storage medium of claim 15, wherein the indications as to which of the sample job posting search results were selected by members performing corresponding job posting search queries include indications as to jobs corresponding to sample job posting search results that were applied to by the members performing the corresponding job posting search queries.

17. The non-transitory machine-readable storage medium of claim 15, wherein the global ranking model is a Learning to Rank (LTR) model.

18. The non-transitory machine-readable storage medium of claim 15, wherein the job posting result ranking model uses logistic regression.

19. The non-transitory machine-readable storage medium of claim 15, wherein the job posting result ranking model is optimized via alternating optimization using parallelized coordinate descent.

20. The non-transitory machine-readable storage medium of claim 15, wherein the job posting result ranking model is optimized by optimizing for global features and per-feature queries for each query while holding all other variables fixed.
